(19) United States
(12) Patent Application Publication
(10) Pub. No.: US 2017/0353693 A1
(43) Pub. Date: Dec. 7, 2017

(54) COUPLING A VEHICLE MULTIMEDIA SYSTEM TO AT LEAST ONE MOBILE TERMINAL

(71) Applicant: Continental Automotive GmbH, Hannover (DE)

(72) Inventors: Akos SEMSEY, Regensburg (DE); Dieter NAU, Wetzlar (DE)

(21) Appl. No.: 15/538,999

(22) PCT Filed: Dec. 16, 2015
(86) PCT No.: PCT/EP2015/079924

§ 371 Date: Jun. 22, 2017

(30) Foreign Application Priority Data
Dec. 23, 2014 (DE) 10 2014 226 905.9

(51) Int. Cl. H04N 7/14; H04N 7/15; H04M 1/60; H04M 1/725

(52) U.S. Cl. CPC H04N 7/147; H04M 1/72527; H04N 7/15; H04M 1/6091; H04M 2250/22; H04M 2250/16

(57) ABSTRACT

A vehicle multimedia system includes a connection to a vehicle bus system in the vehicle; there is a data link, via the vehicle bus system, to a seat occupancy system that is used to determine which seats in the vehicle are occupied, and the occupancy of the seats is displayed via a visualization unit of the vehicle multimedia system in accordance with the determined seat occupancy; the display is designed in such a way that at least one mobile terminal of a vehicle passenger can establish a data connection to the vehicle multimedia system in a coupling process, and said mobile terminal/s is/are associated with the respective vehicle passenger via the vehicle multimedia system.

### BACKGROUND

The present invention relates to a vehicle multimedia system and a method for connecting a vehicle multimedia system to at least one mobile terminal in a data link.

U.S. Pat. No. 5,808,661 A discloses a communication system for an aircraft. The communication system comprises, inter alia, a camera for capturing a flight attendant and a plurality of screens at seats of the passengers on which video images recorded by the camera are outputtable.

US 2010/0257251 A1 discloses a method of tapping two mobile phones against one another, recording the vibration by means of a respective acceleration sensor in each of the mobile phones and then starting a Bluetooth survey in order to connect the two devices in the environment that have experienced a vibration more or less at the same time.

WO 2008/119050 A2 discloses the practice of operating two touch-sensitive input elements on two devices at the same time and also checking synchronism in the process and taking it as a basis for setting up contact between the devices.

US 2005/1132234 A1 discloses the practice of the introduction of a portable device in the holder of a fixed device prompting two keys/switches on the device and holder to be operated, the devices being wirelessly connected to one another in this case too based on synchronism—but in this case the keys/switches remain operated for as long as the mobile device remains in the holder.

US 2007/0003061 A1 discloses the practice of setting up a connection between two devices by virtue of sensors (possibly integrated in touchscreen) recognizing direct contact between the devices—information required for setting up contact can be interchanged wirelessly or else via the point of contact between the devices themselves in this case. There is no indication of a check on synchronism in this case, however.

US 2006/0267860 A1 describes the connection setup when two sensors (possibly integrated in touchscreen) are pushed at the same time, and the check on synchronism. In this case, however, there is no mention of the touch on the respective sensors also being able to be provided by the respective other device.

It is an object of the invention to provide a vehicle multimedia system and a method that allows simple connection of mobile terminals to a vehicle multimedia system and overcomes the disadvantages of the prior art.

Communication devices—particularly mobiles and smartphones—have various options for setting up wireless connections to other devices in their environment, whereby data, electronic business cards or images can be interchanged.

The greater the number of connection options, the more complicated it is for the user to select them when the user wishes to set up a data link to another device in the environment. In this regard, terminals today are already often far too complicated for many non-technocentric users. For this reason, such functions are not used in an optimum fashion. Moreover, a constantly active search function for other devices, for example using Bluetooth, gives rise to shorter storage battery lives and can have an irritating effect, since the mobile or smartphone constantly reports new devices in the environment, particularly when there are multiple passengers with their terminals in a vehicle.

### BRIEF SUMMARY

The object is achieved by a vehicle multimedia system having a connection to a vehicle bus system of a vehicle that has a data link via the vehicle bus system to a seat occupancy system, wherein the seat occupancy system is used to ascertain which seats in the vehicle are occupied and the occupancy of the seats is taken as a basis for displaying the occupancy via a visual display unit of the vehicle multimedia system, wherein the display is designed such that at least one mobile terminal of a vehicle passenger is connectable to the vehicle multimedia system in a data link by a coupling process and the respective mobile terminal is associated with the respective vehicle passenger logically and in a data link via the vehicle multimedia system.

A further configuration of the vehicle multimedia system is distinguished in that the connection to the vehicle bus system is in a wired and/or mobile embodiment.

The object is achieved by the method according to the invention for connecting a vehicle multimedia system to mobile terminals, wherein the connection setup is initiated by a common trigger event, wherein a check on the timing synchronism is performed based on the detection of the respective trigger events of both devices and the common trigger event arises as a result of mechanical coupling between the vehicle multimedia system and the mobile terminal.

In one advantageous configuration of the method for connecting a vehicle multimedia system to mobile terminals, the detection of a trigger event is effected in one or both devices by a mechanical switch or by ascertainment of a mechanical action of force on a surface.

A further particularly advantageous configuration of the method for connecting a vehicle multimedia system to mobile terminals is distinguished in that the detection of the trigger event is implemented in one or both devices by identification of the specific signal profile patterns of motion sensor signals.

The method according to the invention for connecting a vehicle multimedia system to mobile terminals is particularly advantageous if the check on the timing synchronism of the trigger events is based on a comparison between time information that is communicated wirelessly between a mobile terminal and the vehicle multimedia system at least in one direction after the trigger event.

Advantageously, the invention indicates an efficient approach to how the connection setup between a mobile terminal, such as a mobile or smartphone, and a vehicle multimedia system or a permanently installed infotainment device can be effected, wherein the mobile terminal is equipped with an acceleration sensor and the permanently installed device is equipped with a touch sensor.

In this case, it is particularly advantageous that the vehicle multimedia system in the form of a permanently installed device allows location-dependent touch in order to stipulate the depth of access so that e.g. the driver can ‘click in’ as such and hence calls arriving for the driver can be forwarded to the hands-free device via the vehicle multimedia system, while the front-seat passenger or the other vehicle occupants or passengers can reveal themselves as such and the calls intended for them are diverted directly to their respective associated mobile terminal or seat-related permanently installed output devices.

On connection setup, an outline of the vehicle interior is presented by means of the reproduction unit (HMI) of the vehicle multimedia system and each passenger can use his mobile device to tap on his presented seat. As such, not only can information be forwarded to the respective mobile device, it is also possible for seat-related output devices, such as e.g. monitors with better image quality than the mobile screen or headphone sockets with better sound quality than the mobile audio output, to be actuated via the vehicle multimedia system as appropriate.

For this reason, the vehicle multimedia system has not only the central main screen but also secondary screens that are arranged at the rear seats, e.g. in the headrests of the front seats and/or centrally between the front seats or centrally on the roof lining.

This advantageously obviates the need particularly for passengers at the rear to pass the mobile device to the front in order to activate the touch-sensitive field of the vehicle multimedia system arranged in the central console so that registration on the vehicle multimedia system can take place in this manner. As an alternative to touching the seat presentation on one of the screens at the rear, there may also be a touch-sensitive panel/sensor arranged directly at the respective seat.

### BRIEF DESCRIPTION OF THE DRAWINGS

An exemplary embodiment of the invention is presented in the drawings and is described in more detail below.

In the drawings,

FIG. 1 shows a schematic presentation of the seats in a passenger compartment, and

FIG. 2 shows the depiction of the HMI of the reproduction unit of the vehicle multimedia system for connecting the mobile terminals in a vehicle having five seats,

FIG. 3 shows the depiction of the HMI of the reproduction unit of the vehicle multimedia system for connecting the mobile terminals in a vehicle having 8 seats.

### DETAILED DESCRIPTION

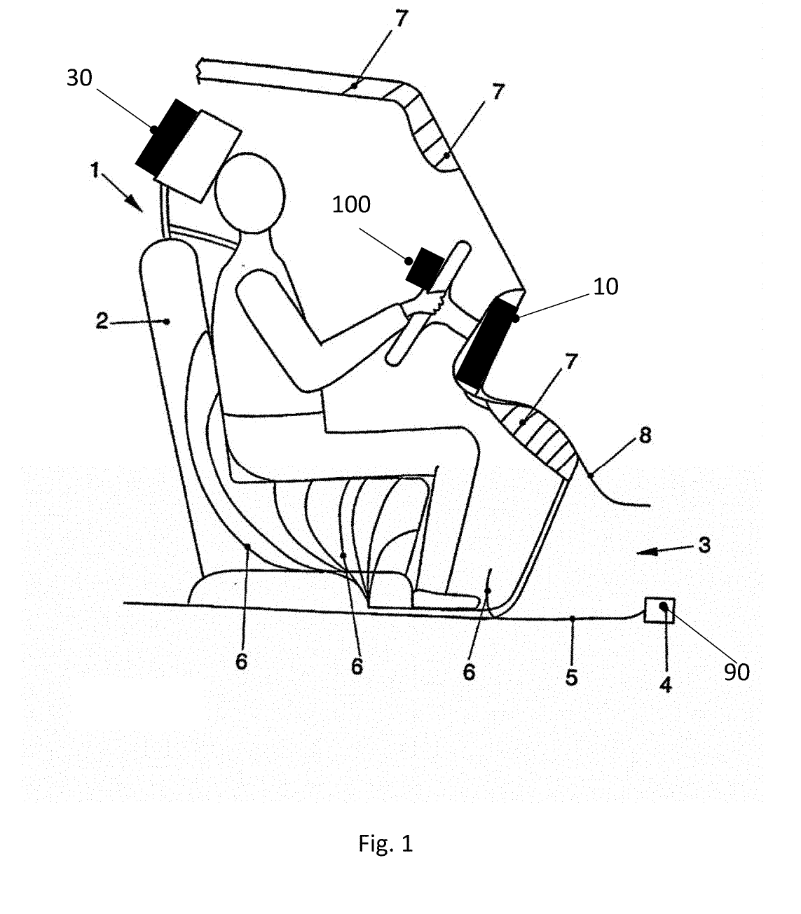

The passenger compartment contains the seats of the passengers. The embodiment of the known seat recognition can be regarded as exemplary and should not be interpreted as limiting. FIG. 1 shows, by way of example, a passenger compartment 1 of a motor vehicle with an occupied vehicle seat 2. To recognize whether and how a vehicle seat 2 in the motor vehicle is occupied, a seat occupancy system 3 is arranged in the motor vehicle for the purpose of seat recognition. By way of example, the seat occupancy system 3 comprises an optical transmitter 4 that has an associated first optical fiber bundle 5 whose individual fibers or optical fibers 6 are arranged in, at and around the vehicle seat 2. Each optical fiber 6 has an associated further optical fiber 7 that is arranged in the beam path of the first optical fiber 6. The optical fibers 7 are likewise combined to form an optical fiber bundle 8 and are routed to an optical detector, which is not shown. The optical fibers 6 are arranged such that they cover the whole seat position or contour of the vehicle occupant. To control seat occupancy system 3, it is possible in this case for at least one optical fiber 6 with a corresponding optical fiber 7 to be arranged such that there can never be an object between the two optical fibers 6, 7, so that this reference distance can be used to check the functionality of the seat occupancy system 3.

The optical transmitter 4 comprises a light source 9, an IR source and a laser, which can optionally use an optical system to launch radiation into the optical fiber bundle 5. The optical transmitter and the optical detector, which is preferably in the form of a camera, are connected to one another via a line. The optical detector is connected to an evaluation unit that transfers its results via a vehicle data bus connection 90 to vehicle occupant restraint systems, not shown, such as an airbag or seat belt tensioner, for example, and via a wireless or wired vehicle bus to the vehicle multimedia system A.

This evaluation unit is used to pass the information about the occupancy of the seats to the vehicle multimedia system.

A property of the seat occupancy system is that the optical fibers 6, 7 allow the optical transmitter 4 and the optical detector to be arranged at a great physical distance from the location of the actual sensing. Fitting then requires only the insensitive optical fibers to be laid in the passenger compartment 1, these being highly adjustable in relation to one another on account of their flexibility. To this end, the optical transmitter 4 can be switched to operation with the light source, so that the adjustment can easily be checked and if need be re-corrected on the basis of visual perception. Similarly, the light source can be used for maintenance work and checks. During actual operation, the IR source is preferably used. If the seat recognition system 3 now receives an activation signal, for example from a door state sensor or an ignition signal, the IR source is selected and launches its radiation into the optical fiber bundle. In order to reject interfering influences by external light sources, the optical transmitter 4 and the optical detector are synchronized to one another via the line. If the IR light source now emits an impulse, the synchronism means that the optical detector can easily attract background radiation that is present. Similarly, the signal emitted can be modulated. If there is an object, for example a leg, between two optical fibers 6, 7, then the optical fiber 7 receives no radiation. Hence, a digital contour of the vehicle seat 2 arises at the optical detector and can then be evaluated in the evaluation unit by means of reference images, for example. After certain periods, the laser can then be briefly launched in order to compensate for distortions on account of smoke in the passenger compartment 1. The seat recognition system 3 can be operated either continuously or in a manner conditional upon the situation in this case.

Electronic systems in the vehicle have a complex networked structure today in which many distributed hardware and software components have to interact in order to implement the desired functions. Smooth interplay is possible only using reliable communication networks. According to the invention, it is planned for the vehicle multimedia system to have at least one interface for connection to a bus system in a vehicle, which interface can be used to interchange information and data with the seat recognition system. The interface can be used to address a vehicle bus system, such as K-line, CAN, CAN FD, LIN, FlexRay, Automotive Ethernet/IP, SAE J1850, MOST, PSI5, SENT, ASRB. Possible transport protocols used are ISO TP, TP 1.6/2.0 and SAE J1939 for CAN, AUTOSAR TP for FlexRay. By means of these, diagnosis protocols, such as KWP 2000, UDS, OBD, are used to check correct functionality and the protocols used for the application and production are CCP, XCP, ASAM MCD, ODX, OTX, FIBEX. Furthermore, standardized software components, such as OSEK/VDX, HIS, AUTOSAR are used to implement the functionality. The vehicle multimedia system has telematics communication such as car-to-car, car-to-infrastructure (Car2x), LTE, UMTS, GPRS, GSM and known 3 gpp functions that can depict 3G, 4G and wideband applications, such as DVB T functions. All in all, the vehicle multimedia system acts as a server or control center in order to manage the terminals introduced as a client-server architecture and to address resources that are in the vehicle multimedia system, or other components installed in the vehicle, via the vehicle multimedia system.

The vehicle multimedia system according to the invention has at least one screen arranged in the vehicle interior, as denoted by 10 and 30 in FIG. 1. Further, the vehicle multimedia system comprises a control unit that is connected to the at least one screen and can be used to output data and information that can be stored on the mobile terminals or received in real time, such as e.g. a telephone call.

The vehicle multimedia system according to the invention allows images, preferably video image sequences, to be output on one or more screens. By way of example, images of passengers in the rear seats can be output on a screen visible to the driver and front-seat passenger. This improves communication convenience of the vehicle occupants in the vehicle by means of visual display of the interlocutor, and facilitates observation of the traffic for the driver, for example, which increases driving safety.

FIG. 1 shows a vehicle having a vehicle multimedia system according to the invention having the screens 10 and 30, and also a control unit, not shown, that is connected to the seat capture system 3 via a vehicle bus 90.

The screen 10 is preferably arranged centrally on the dashboard of the vehicle or integrated in the dashboard, so that it is visible to the driver and the front seat passenger.

The control unit is connected to the screens 10 and 30. The control unit can be used to activate the cameras 1 to 3 and the screens 4 to 6, preferably independently of one another. Further, the control unit can be used to control the output of the camera images on the screens 10 to 30.

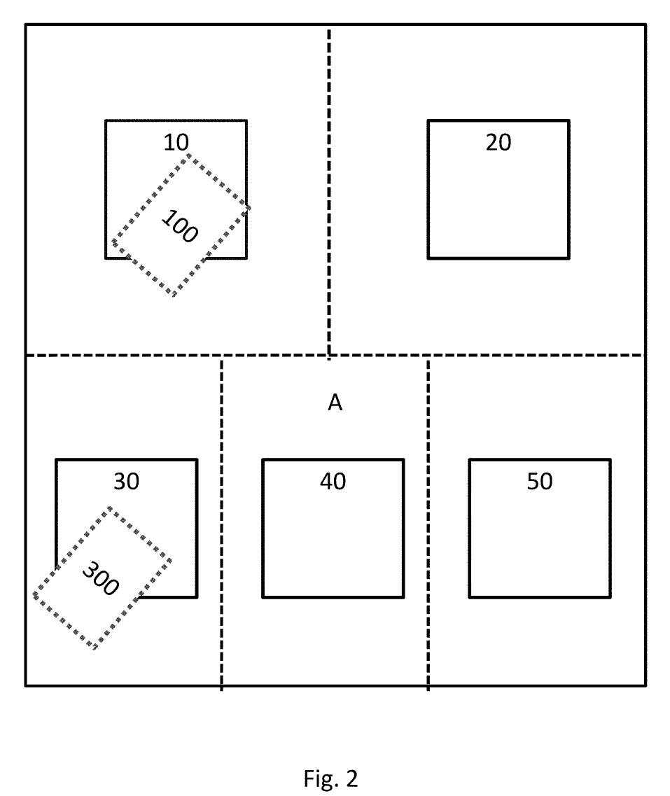

Preferably, the signals produced by the seat recognition system for the occupancy of the respective seats are in this case used in order to activate the cameras associated with the respective seats and to output the camera images at least on the first screen of the vehicle multimedia system A, as shown in FIG. 2, the camera images additionally being presented on the second screen 30 and/or on the further screens 20, 40, 50.

This advantageously allows the driver and the front seat passenger to see the vehicle occupants in the rear seats 30, 40, 50 on the first screen 10, and the vehicle occupants in the rear seats can view the seats of the driver and/or the front seat passenger on the second screen 30 and/or on a third screen, which is arranged behind the front seat passenger's seat.

In one advantageous configuration of the invention, the control unit is connectable to a navigation system in the vehicle, so that the image output on the screens 10 to 50, and 80, is controllable via the navigation system.

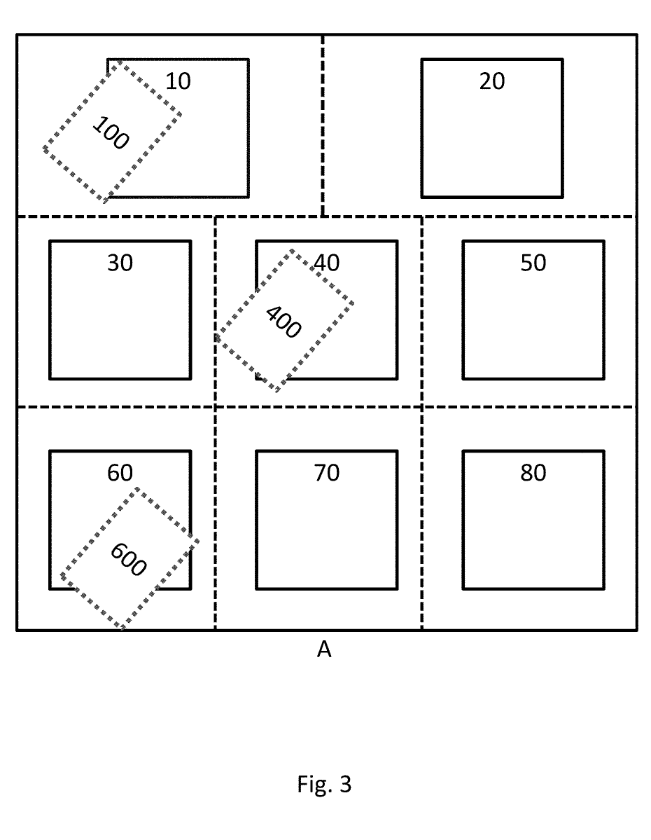

This avoids a single control panel for the controller on the dashboard. Further, this allows the output of the information delivered e.g. by the navigation system about a journey route and/or a traffic situation to be output on the second screen 30 and/or the further screen and thus made available to the vehicle occupants in the rear seats. The seats shown in FIGS. 2 and 3 are exemplary and are used for illustration for a vehicle having five or eight seats.

In principle, connection setup is triggered by a common trigger event, wherein a check on the timing synchronism of the trigger events is performed and wherein the common trigger event arises as a result of mechanical coupling of the vehicle multimedia system and the mobile terminal.

As such, connection setup is implemented by the detection of the trigger event in one or both devices, e.g. by a mechanical switch or by detection of a mechanical action of force on a surface.

Alternatively, the connection setup can also be implemented by the detection of a trigger event in one or both devices by recognition of specific signal profile patterns of motion sensor signals or by the check on the timing synchronism of the trigger events based on a comparison of the time information that is communicated between the two devices wirelessly in at least one direction after the trigger event.

If the driver, as indicated in FIG. 1, or one of the passengers now wishes to connect his accompanying smartphone 100/300 to the vehicle multimedia system, then the driver or the passenger taps this terminal on the respective panel 10 or 30 of the screen of the vehicle multimedia system.

The touch on the screen on one of the panels 10 and 30 is recognized in the vehicle multimedia system by means of the touch-sensitive screen and interpreted as a trigger event, which is provided with a time stamp. The bumping of the mobile terminal on the screen is recognized in the mobile terminal by an acceleration sensor located in the mobile terminal and is interpreted as a trigger event, which is likewise provided with a time stamp.

Based on the recognition of the trigger event in the vehicle multimedia system, the latter transmits a connection request that contains the time stamp of the trigger event.

The mobile terminal receives the connection request, including the time stamp, and performs a comparison of the received time stamp of the trigger event detected in the vehicle multimedia system with the time stamp of the trigger event detected in the mobile terminal.

If the two time stamps are identical or if the ascertained time difference is only very slight, then the two trigger events are rated as a joint trigger event and a connection between the two devices is set up.

Alternatively, the mobile terminal can transmit the connection request with the time stamp of the trigger event, whereupon the timing synchronism is checked by the vehicle multimedia system and a connection setup is performed if the timings match.

When the mobile terminal is connected to the vehicle multimedia system, the vehicle multimedia system can act as a relay station that manages the communication between the mobile terminal and the outside world. In this case, it is possible to use e.g. transmission and reception devices of the vehicle that have a higher transmission power and/or better signal processing options, particularly with regard to reception during fast movement, than the mobile terminal. Similarly, permanently installed output devices of the vehicle multimedia system can be used that have a higher reproduction quality than the mobile terminal.

To this end, immediately after the connection setup between the vehicle multimedia system and the mobile terminal, temporary call diversion is initiated for the mobile terminal, so that incoming calls can be received by the vehicle multimedia system and the more powerful infrastructure thereof and forwarded to the mobile terminal and/or to seat-related output devices.

If multiple mobile terminals are connected to the vehicle multimedia system, the vehicle multimedia system can act as a base station and set up a direct communication link between these devices. This is advantageous particularly in the case of larger vehicles, such as the 8-seat motor vehicle shown in FIG. 3, since in this case a conversation e.g. between the driver and a passenger in the second rear row of seats is possible only with very great difficulty, since the driver cannot turn to the passenger.

In this case, the communication link can either be setup on the basis of the mobile phone standard or can be provided within the limited vehicle interior purely by means of near field communication standard (e.g. Bluetooth). The latter is advantageous particularly when only mobile terminals inside the vehicle are involved in the communication.

As such, e.g. the front seat passenger can tap on the button for his own seat presented on the screen and at the same time or promptly thereafter tap on the button for another seat in order to set up a voice link between the mobile terminals associated with these seat positions. Alternatively, it is possible for the button associated with the first seat on the first screen to be tapped on by a first vehicle occupant and for the button associated with a second seat on a second screen to be tapped on at the same time or promptly thereafter by a second vehicle occupant.

If there is already a connection between the vehicle multimedia system and the mobile terminals in this case, the tapping on the button does not need to be effected using the mobile terminals, but rather can be carried out with the finger—it is thus possible for the user of the mobile terminal to leave the latter e.g. in his jacket pocket.

After the connection is set up, it can be rendered visually discernible on the display unit, e.g. by virtue of the two buttons for the interconnected seats having a changed joint frame color that is distinguished from the frame color of the seats not involved in a communication.

As a further embodiment, instead of the connection between two devices, a conference call can be set up between multiple devices located in the vehicle. In this case, the respective buttons are preferably operated at the same time, since a successive operation of e.g. four buttons could also be interpreted as two single connections between the first and second seats and the third and fourth seats.

A check for timing synchronism of the touches is effected in the vehicle multimedia system. It is particularly advantageous in this case is for the buttons of the screen not only to be tapped but also to be kept depressed for longer in order to ensure and be able to recognize synchronism more reliably. Tapping on the respective buttons on one of the screens is advantageously rendered visually distinguishable on all screens (e.g. particularly as a result of a brightness change for the frame of the button), so that all occupants involved are able to verify whether a touch by the other participants is currently taking place. As such, incorrect operation or non-connection on account of uncoordinated touches can be prevented (example: passenger 1 releases his button again before passenger 2 has pushed his button). Connection setup is effected after all buttons involved have been released again.

As a further embodiment, it is also possible for multiple parallel communication links to be set up within the vehicle. After a first connection has been set up, the same method as described above can be used to set up at least one second connection—tapping on the respective buttons (for seats not involved in a communication) sets up the second connection between the associated seats.

Extension of a conference call is also possible in this way—tapping on the button for a seat that is already in a conference call and tapping on the button for a seat that is not involved in a conference call at the same time or promptly thereafter initiates the inclusion of the as yet uninvolved seat in the conference call.

The interconnection of multiple single connections to form a conference call is also possible in this way by first of all tapping on one of the buttons for the seat associated with a first single connection and tapping on the button for a seat associated with a second single connection at the same time or promptly thereafter, which interconnects the 4 participants to form a conference.

Advantageously, the buttons for the respective single connections are visually identified as being associated with one another in this case, e.g. by the same coloration of the frame of the buttons, the coloration of the first single connection being markedly different than the coloration of the second single connection and from the primary color of the seats not involved in the connection. This allows an incorrect selection to be avoided.

In a similar manner to inclusion in a conference call, long tapping on the button for a seat involved in the conference call can terminate the connection to the conference call.

Accordingly, a single connection that has been added to a conference call can be disconnected from the conference call by a long push, a distinction being able to be drawn between the following two cases:

a) in the event of a long push by only one of the two participants in an original single connection, only this participant leaves the conference call,

b) in the event of both participants on an original single connection pushing at the same time, both participants leave the conference call, with reversion to the single connection of the two participants.

Pushing of the two buttons at the same time can also be effected by a single participant.

In a further configuration of the invention, the control unit is additionally or alternatively connectable to one or more mobile communication and/or data processing devices, for example a mobile phone and/or a portable computer. To this end, the control unit preferably has one or more interfaces via which it is connectable to such devices by cable and/or wirelessly by means of electromagnetic waves.

Suitable interfaces are Bluetooth, infrared, USB and/or Firewire interfaces, for example, or the aforementioned bus technologies.

A vehicle multimedia system configured in this manner having at least one interface to a mobile phone and/or to another mobile communication device having a reception unit for wirelessly transmitted audio signals further preferably has a hands-free unit that can be used to output audio signals received from the mobile phone and/or the mobile communication device, for example voice messages, so as to be audible to the vehicle occupants.

This allows the vehicle occupants to conduct video conferences with remote conference participants. In particular, this allows a business or private communication in the form of a video conference to be held during a journey. This configuration of a vehicle multimedia system is advantageously suitable, inter alia, for use in a truck, since a driver of a truck is often on the road for a relatively long time and can also make visual contact with his employer, his colleagues and/or family members by means of video conferences.

1. A vehicle multimedia system having a connection to a vehicle bus system of a vehicle, characterized in that it has a data link via the vehicle bus system to a seat occupancy system and the seat occupancy system is used to ascertain which seats in the vehicle are occupied and the occupancy of the seats is taken as a basis for displaying this occupancy via a visual display unit of the vehicle multimedia system, wherein the display is designed such that at least one mobile terminal of a vehicle passenger is connectable to the vehicle multimedia system in a data link by a coupling process and the respective mobile terminal is associated with the respective vehicle passenger via the vehicle multimedia system.

2. The vehicle multimedia system as claimed in claim 1, characterized in that the connection to the vehicle bus system is in a wired and/or mobile embodiment.

3. A method for connecting a vehicle multimedia system to mobile terminals in a data link, characterized in that the connection setup is triggered by a common trigger event, wherein a check on the timing synchronism of the detection of the trigger events is performed and the common trigger event arises as a result of mechanical coupling of the vehicle multimedia system and the mobile terminal.

4. The method for connecting a vehicle multimedia system to mobile terminals as claimed in claim 3, characterized in that the detection of the trigger event is implemented in one or both devices by a mechanical switch or by detection of a mechanical action of force on a surface.

5. The method for connecting a vehicle multimedia system to mobile terminals as claimed in claim 4, characterized in that the detection of the trigger event is implemented in one or both devices by recognition of specific signal profile patterns of motion sensor signals.

6. The method for connecting a vehicle multimedia system to mobile terminals as claimed claim 5, characterized in that the check on the timing synchronism of the trigger events is based on a comparison between time information that is communicated between the two devices wirelessly at least in one direction after the trigger event.
